(19) United States
(12) Patent Application Publication
(10) Pub. No.: US 2006/0100864 A1
(43) Pub. Date: May 11, 2006

(54) Process and computer program for managing voice production activity of a person-machine interaction system

(76) Inventors: Eric Paillet, Tregastel (FR); Dominique Dubois, Pleumeur-Bodou (FR); Glenn Merour, Lannion (FR)

Correspondence Address: FISH & RICHARDSON P.C., PO BOX 1022, MINNEAPOLIS, MN, 55440-1022, US

(21) Appl. No.: 11/253,292

(22) Filed: Oct. 18, 2005

(30) Foreign Application Priority Data
Oct. 19, 2004 (FR) 0411093

(51) Int. Cl. G10L 11/06

(52) U.S. Cl. 704/214

(57) ABSTRACT

The invention concerns a management process of voice production activity of a person-machine interaction system with voice component, consisting especially of detecting and capturing external acoustic activity originating from an agent external to the system, and analyzing the semantic contents of any statement optionally included in the external acoustic activity. The inventive process includes measuring of an overlap period of the external acoustic activity and of the voice production of the system, a process for inhibiting any interruption of the voice production of the system for as long as the duration of the overlap period remains less than a limited predetermined duration, and an interruption process of the voice production of the system in the case where, simultaneously, the external acoustic activity is assimilable to voice activity and where the duration of the overlap period attains or exceeds the limited duration.

### CROSS REFERENCE TO RELATED APPLICATION

This application claims the benefit of French Application No. 0411093, filed Oct. 19, 2004, the contents of which are hereby incorporated by reference in its entirety.

### TECHNICAL FIELD

The present invention concerns, in general terms, interactive voice services utilizing word recognition for communications in natural language.

More precisely, the invention concerns, according to a first of its aspects, a management process with voice production activity of a person-machine interaction system with voice component, especially with voice recognition and voice production, this process comprising operations consisting of exercising the activity of voice production of the system for example by producing statements, detecting and capturing external acoustic activity emanating from an agent external to the system, and analyzing the semantic contents of any statement optionally included in the external acoustic activity.

### BACKGROUND

Within the scope of the utilization of interactive voice services equipped with word recognition functionality, it eventuates that the user speaks while the server being addressed broadcasts a voice guide at the same time.

For this reason, interactive voice systems often offer intervention functionality in force, known to the specialist under the English name “barge-in”, this functionality offering the user of such an interactive system the possibility of interrupting, via oral intervention, the voice production of this system (human voice or synthesis, real time or registered, music, noises, sound, etc.) to be able to formulate a request.

The classic functioning of “barge-in”, such as is provided for example in the standard VoiceXML 2, defines two cases of quite distinct utilization, namely (1) the interruption of the guide can be immediate, that is, performed as soon as a noise (or a word) is detected, and (2) the interruption of the guide can be done only when the voice recognition motor of the system returns the result of its analysis.

This function is not adapted to voice services in natural language (also known as continuous word services) for the following reasons.

First of all immediate interruption of the guide as soon as a noise or a word is detected poses the problem that the user of a voice service can evolve in a noisy environment, such that the guides will be systematically interrupted as soon as a noise is detected by the server.

The case where the guide is interrupted only when the voice recognition motor returns a result is not more satisfactory for voice services in natural language, since the sentences pronounced by the user are, in fact, potentially long and complex. The result is a corresponding growth in processing time by the voice recognition module, such that the voice guides will not be interrupted fast enough. In fact, the experiments carried out tend to show that the users stop speaking when they perceive that the server has not interrupted the voice guide sufficiently precociously, typically within a period of the order of one to two seconds from the start of voice intervention by the user.

### SUMMARY

In this context, the particular aim of the invention is to propose a process for managing the voice production activity of a person-machine interaction system with vocal component exempt from the abovementioned disadvantages.

For this purpose, the process according to the present invention, furthermore in accordance with the generic definition given by the preamble hereinabove, is essentially characterized in that it further comprises an overlapping measuring operation consisting of measuring the duration of an overlap period of the external acoustic activity and of the activity of voice production of the system, and a decision process consisting at least of inhibiting any premature interruption of the voice production activity of the system as long as the duration of the overlap period remains less than a limited predetermined duration, and interrupting the voice production activity of the system in the case where, at one and the same time, the external acoustic activity is assimilable to a voice activity and where the duration of the overlap period attains or surpasses the limited duration, this limited duration preferably able to be being regulated.

For example, the decision process can further consist at least of reprising, after interruption, the voice production activity of the system in the case where the vocal activity detected by the external agent is not recognized as a carrier of a statement adapted to possible interaction between this external agent and the system.

In the case where the voice production activity of the system has been interrupted and where the voice activity detected by the external agent is not recognized as a carrier of a statement adapted to possible interaction between this external agent and the system, the decision process can further consist at least of relaunching the voice production activity of the system from the status of advancement in which this voice production was at the latest at the end of the overlap period.

In addition, in the case where the production activity of the system has been interrupted and where the activity detected by the external agent is recognized as a carrier of a statement adapted to possible interaction between this external agent and the system, the decision process can further consist at least of selecting and triggering fresh voice production activity of the system, adapted to possible interaction.

The invention likewise concerns a computer program for managing voice production activity of a person-machine interaction voice system, especially with voice and sound recognition, this program comprising a sound or acoustic module responsible for the voice activity of the system, a detection module for surveilling the appearance of external activity originating from an external agent to the system, a word recognition module for decomposing in a sequence of words any statement optionally included in the external acoustic activity, and a semantic analysis module, optionally combined with the recognition module, and used for analyzing the semantic contents of such a sequence of words, this program being characterized in that it further comprises a voice production management module for triggering, with the appearance of external acoustic activity during a period of voice production activity of the system, measuring of the duration of the overlap period of the external acoustic activity and of the voice production activity of the system, suitable for inhibiting any premature interruption of the voice production activity of the system for as long as the duration of the overlap period remains less than a limited predetermined duration, and for interrupting the voice production activity of the system in the case where, at the same time, the external acoustic activity is assimilable to voice activity and or the duration of the overlap period attains or exceeds the limited duration.

Preferably, the voice production management module is likewise for reprising, after interruption, the voice production activity of the system in the case where the vocal activity detected by the external agent is not recognized as a carrier of a statement adapted to possible interaction between this external agent and the system.

The voice production management module can further be suitable, following interruption of the voice production activity of the system and an assimilation abort of the voice activity detected by the external agent to a statement adapted to possible interaction between this external agent and the system, to relaunch the voice production activity of the system from the status of advancement in which this voice production was situated at the latest on completion of the overlap period.

It is likewise judicious to provide that the voice production management module is suitable, after interruption of the voice production activity of the system and completed assimilation of the voice activity detected by the external agent to a statement adapted to possible interaction between this external agent and the system, to trigger fresh voice production activity of the system, adapted to possible interaction.

Finally, the voice production management module is advantageously designed to allow regulating of the limited duration.

Other characteristics and advantages of the invention will emerge clearly from the following description, by way of indication and in no way limiting, in reference to the attached diagram whereof the sole figure is an operating plan simultaneously illustrating the process and the program according to the present invention.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 shows a flow chart of a process under control of a computer program.

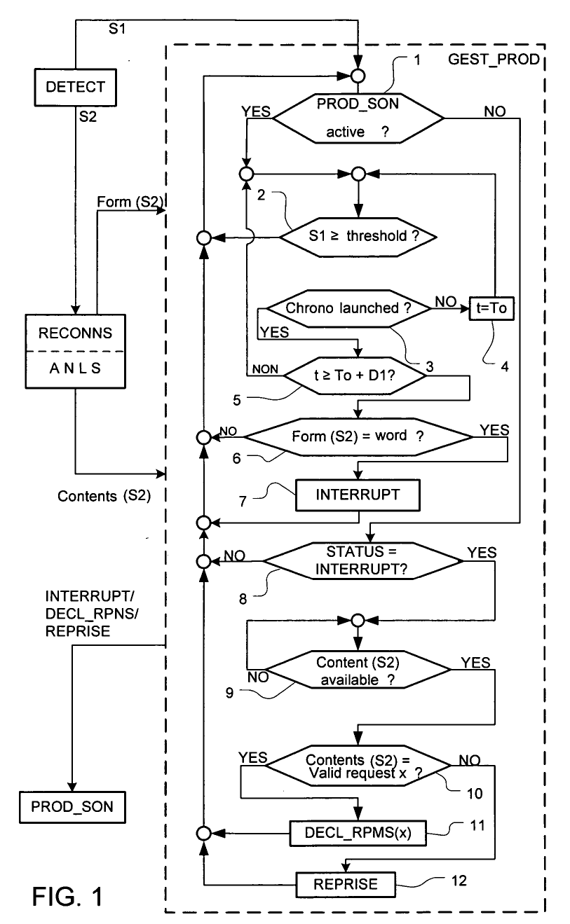

### DETAILED DESCRIPTION

As previously mentioned, an object of the inventive process, which is typically utilized by a computer program, is to manage the voice production activity of a person-machine interaction system with voice component, in particular a system equipped with voice recognition functionality and voice production functionality.

This system thus comprises a voice or acoustic production module PROD_SON, responsible for voice production activity of the system and capable of broadcasting for example sound files, even voice synthesis.

This system likewise comprises an acoustic detection module DETECT for surveilling the appearance of external acoustic activity originating from any agent external to the system, for example a user of this system or its sound environment.

On the other hand, this system comprises a word recognition module RECONNS for decomposing in a sequence of words any statement optionally included in external acoustic activity, as well as a semantic analysis module ANLS, optionally combined with recognition module RECONNS, and suitable for analyzing the semantic contents of such a sequence of words, and thus of any word pronounced by the user.

With the appearance of external acoustic activity originating from an external agent, the detection module DETECT produces output signals such as S1 and S2.

The first signal S1 contains at least the information of the start of the external acoustic activity and its sound intensity.

The second signal S2, which is transmitted to the RECONNS word recognition module, reflects integrally the contents of this acoustic activity, selectively attenuated, if required, beyond the range of frequencies of the word.

After receiving the signal S2, this recognition module RECONNS delivers, within a relatively short period, a first output signal Form (S2) informing of the vocal nature or not of the external acoustic activity and thus distinguishing between the case where this activity is attributable to the word and that where it is attributable only to noises, after which the analysis module ANLS delivers, within a relatively longer period, a second output signal Contents (S2), informing of the semantic contents of the external acoustic activity, when the latter is of voice type.

According to the present invention management of the voice production activity of the system is confided to a voice production management module GEST_PROD which unites the principal characteristics of the invention and which receives the signals S1, S2, Form (S2), and Contents (S2).

A possible example of functional organization of the management module GEST_PROD is described hereinafter in reference to FIGURE.

The GEST_PROD module first performs an operation 1 consisting of determining if the voice production module PROD_SON, is or is not in the midst of activity.

In the negative, the module GEST_PROD performs a processing jump to an operation 8, constituted by a test which will be described hereinbelow.

In the affirmative, the module GEST_PROD performs an operation 2 consisting of determining if the signal S1 representative of the external acoustic activity attains or exceeds a predetermined minimum threshold.

In the negative, the module GEST_PROD repeats its processing on the operation 1.

In the affirmative, the module GEST_PROD performs an operation 3 consisting of determining if a chronometer for measuring the overlap duration of the external acoustic activity and of the voice production of the system has been launched.

In the negative, the module GEST_PROD performs an operation 4 consisting of triggering the chronometer by memorizing, in the form of a constant instant To, the value of the current instant, then repeats its processing on the operation 2.

In the affirmative, the module GEST_PROD performs an operation 5 consisting of determining if a duration D1, of parametrable value, has or has not elapsed since the triggering instant To of the chronometer.

In the negative, the module GEST_PROD repeats its processing on the operation 2.

In the affirmative, the module GEST_PROD performs an operation 6 consisting of determining whether the signal Form (S2) attributes or not the acoustic activity to voice activity.

In the negative, the module GEST_PROD repeats its processing on the operation 1.

In the affirmative, the module GEST_PROD performs an operation 7 consisting of producing a destination of the voice production module PROD-SON, an INTERRUPT command, the effect of which is to interrupt the voice production of this module PROD_SON, the module GEST_PROD then repeating its processing on the operation 1.

In the case where the voice production module PROD-SON is not in activity, the module GEST_PROD performs an operation 8 already mentioned hereinabove and consisting of determining if the status in which the voice production module PROD_SON, is situated results or not from reception of an INTERRUPT interruption command.

In the negative, the module GEST_PROD repeats its processing on the operation 1.

In the affirmative, the module GEST_PROD performs an operation 9 consisting of determining if the signal Contents (S2) has already been delivered by the semantic analysis module ANLS.

In the negative, the module GEST_PROD repeats its processing on the operation 9.

In the affirmative, the module GEST_PROD performs an operation 10 consisting of determining if the signal Contents (S2) expresses a valid request X to which the voice production system PROD_SON could contribute an appropriate response.

In the affirmative, the module GEST_PROD performs an operation 11 consisting of producing,˜destination of the voice production module PROD_SON, a command DECL RPNS (X) the effect of which is to contribute to the external agent having produced the statement Contents (S2), that is, typically a user of the system, a response appropriate to its request, then repeats its processing on the operation 1.

In the negative, the module GEST_PROD performs an operation 12 consisting of producing, & destination of the voice production module PROD_SON, a REPRISE command, the effect of which is to relaunch the voice production previously underway and prematurely interrupted.

It is possible to ensure that the voice production of the module PROD_SON, is relaunched either after its debut, or from the status of advancement in which it was situated at the triggering instant To of the chronometer, or again from the instant when this voice production was interrupted, that is, at the latest at the end of the overlap period between the external acoustic activity and this voice production.

Finally, the GEST_PROD module repeats its processing on the operation 1.

A number of embodiments of the invention have been described. Nevertheless, it will be understood that various modifications may be made without departing from the spirit and scope of the invention. Accordingly, other embodiments are within the scope of the following claims.

What is claimed is:

1. A process for management of voice production activity of a person-machine interaction system with voice component, especially with voice recognition and voice production, said process comprising:
operations comprising of exercising the voice production activity of the system for example by producing statements, detecting and capturing external acoustic activity originating from an agent external to the system, and analyzing the semantic contents of any statement optionally included in the external acoustic activity;
an overlap measuring operation consisting of measuring the duration of an overlap period of the external acoustic activity and of the voice production activity of the system; and
a decision process comprising inhibiting any premature interruption of the voice production activity of the system for as long as the duration of the overlap period remains less than a predetermined limited duration (D1), and interrupting the voice production activity of the system in the case where, at the same time, the external acoustic activity is assimilable to vocal activity and where the duration of the overlap period attains or exceeds the limited duration (D1).

2. The process as claimed in claim 1, wherein the limited duration (D1) can be regulated.

3. The process as claimed in claim 2, wherein the decision process further comprises reprising, after interruption, the voice production activity of the system in the case where the voice activity detected by the external agent is not recognized as a carrier of a statement adapted to possible interaction between this external agent and the system.

4. The process as claimed in claim 3, wherein, in the case where the voice production activity of the system has been interrupted and where the voice activity detected by the external agent is not recognized as a carrier of a statement adapted to possible interaction between this external agent and the system, the decision process also comprises relaunching the voice production activity of the system from the status of advancement in which this voice production was found at the latest at the end of the overlap period.

5. The process as claimed in claim 4, wherein, in the case where the voice production activity of the system has been interrupted and where the voice activity detected by the external agent is recognized as a carrier of a statement adapted to possible interaction between this external agent and the system, the decision process further comprises selecting the triggering fresh voice production activity of the system, adapted to possible interaction.

6. The process as claimed in claim 1, wherein the decision process further comprises reprising, after interruption, the voice production activity of the system in the case where the voice activity detected by the external agent is not recognized as a carrier of a statement adapted to possible interaction between this external agent and the system.

7. The process as claimed in claim 6, wherein, in the case where the voice production activity of the system has been interrupted and where the voice activity detected by the external agent is not recognized as a carrier of a statement adapted to possible interaction between this external agent and the system, the decision process also comprises relaunching the voice production activity of the system from the status of advancement in which this voice production was found at the latest at the end of the overlap period.

8. The process as claimed in claim 7, wherein, in the case where the voice production activity of the system has been interrupted and where the voice activity detected by the external agent is recognized as a carrier of a statement adapted to possible interaction between this external agent and the system, the decision process further comprises selecting the triggering fresh voice production activity of the system, adapted to possible interaction.

9. The process as claimed in claim 1, wherein, in the case where the voice production activity of the system has been interrupted and where the voice activity detected by the external agent is recognized as a carrier of a statement adapted to possible interaction between this external agent and the system, the decision process further comprises selecting the triggering fresh voice production activity of the system, adapted to possible interaction.

10. A computer program which is suitable, when said program functions on a computer, for managing voice production activity of a person-machine interaction system with a vocal component, especially with voice recognition and sound production, this program comprising:
a voice production or acoustic module (PROD-SON) responsible for voice production activity of the system;
an acoustic detection module (DETECT) for surveilling the appearance of external acoustic activity, originating from an agent external to the system, a word recognition module (RECONNS) for decomposing in a sequence of words any statement optionally included in the external acoustic activity;
a semantic analysis module (ANLS) and suitable for analyzing the semantic contents of such a sequence of words; and
a management voice production module (GEST_PROD) suitable for triggering, with the appearance 3 of an external acoustic activity during a period of voice production activity of the system, measuring of the duration of the overlap period of the external acoustic activity and of the voice production activity of the system, suitable for inhibiting any premature interruption of the voice production activity of the system for as long as the duration of the overlap period remains less than a limited predetermined duration (D1), and suitable for interrupting (INTERRUPT) the voice production activity of the system in the case where, at the same time, the external acoustic activity is assimilable to voice activity, and where the duration of the overlap period attains or exceeds the limited duration (D1).

11. The computer program as claimed in claim 10, wherein, when said program functions on a computer, the voice production management module (GEST_PROD) is likewise suitable for reprising, after interruption, the voice production activity of the system in the case where the voice activity detected by the external agent is not recognized as a statement adapted to possible interaction between this external agent and the system.

12. The computer program as claim in claim 11, wherein, when said program functions on a computer, the voice production management module (GEST_PROD) is suitable, after interruption of the voice production activity of the system and an assimilation abort of the voice activity detected by the external agent to a statement adapted to possible interaction between this external agent and the system, for relaunching voice production activity of the system from the status of advancement in which this voice production was found at the latest by the end of the overlap period.

13. The computer program as claimed in claim 12, wherein, when said program functions on a computer, the voice production management module (GEST_PROD) is suitable, after interruption (INTERRUPT) of the voice production activity of the system and completed assimilation of the voice activity detected by the external agent to a statement adapted to possible interaction between this external agent and the system, for triggering (DECL_RPNS (X)) fresh voice production activity of the system, adapted to possible interaction.

14. The computer program as claimed in claim 13, wherein the voice production management module (GEST_PROD) is designed to allow control of the limited duration (D1), when said program functions on a computer.

15. The computer program as claim in claim 10, wherein, when said program functions on a computer, the voice production management module (GEST_PROD) is suitable, after interruption of the voice production activity of the system and an assimilation abort of the voice activity detected by the external agent to a statement adapted to possible interaction between this external agent and the system, for relaunching voice production activity of the system from the status of advancement in which this voice production was found at the latest by the end of the overlap period.

16. The computer program as claimed in claim 15, wherein, when said program functions on a computer, the voice production management module (GEST_PROD) is suitable, after interruption (INTERRUPT) of the voice production activity of the system and completed assimilation of the voice activity detected by the external agent to a statement adapted to possible interaction between this external agent and the system, for triggering (DECL_RPNS (X)) fresh voice production activity of the system, adapted to possible interaction.

17. The computer program as claimed in claim 16, wherein the voice production management module (GEST_PROD) is designed to allow control of the limited duration (D1), when said program functions on a computer.

18. The computer program as claimed in claim 10, wherein, when said program functions on a computer, the voice production management module (GEST_PROD) is suitable, after interruption (INTERRUPT) of the voice production activity of the system and completed assimilation of the voice activity detected by the external agent to a statement adapted to possible interaction between this external agent and the system, for triggering (DECL_RPNS (X)) fresh voice production activity of the system, adapted to possible interaction.

19. The computer program as claimed in claim 18, wherein the voice production management module (GEST_PROD) is designed to allow control of the limited duration (D1), when said program functions on a computer.

20. The computer program as claimed in claim 10, wherein the voice production management module (GEST_PROD) is designed to allow control of the limited duration (D1), when said program functions on a computer.

21. The computer program as claimed in claim 10, wherein the ANLS is combined with a recognition module (RECONNS).
